(19) United States
(12) Patent Application Publication
(10) Pub. No.: US 2014/0207947 A1
(43) Pub. Date: Jul. 24, 2014

(54) METHODS AND SYSTEMS FOR ONLINE EVENTS

(71) Applicant: ZDIRECT, INC., Hallandale Beach, FL (US)

(72) Inventors: Rowland Hayes THOMAS, Sunny Isles Beach, FL (US); Isaac WIEDER, Hollywood, FL (US); Christopher Shayne PADDOCK, Ottawa (CA); Yadi TANG, Hallandale Beach, FL (US); Jean-Philippe TORUNSKI, Ottawa (CA)

(73) Assignee: ZDIRECT, INC., Hallandale Beach, FL (US)

(21) Appl. No.: 14/158,561

(22) Filed: Jan. 17, 2014

Related U.S. Application Data
(60) Provisional application No. 61/754,290, filed on Jan. 18, 2013.

(51) Int. Cl. H04L 29/08

(52) U.S. Cl. CPC H04L 67/22
USPC 709/224

(57) ABSTRACT

Provided are methods and systems for determining whether an online event has been completed by a user. A website or other interactive service maintains user activity data reflective of the activities of its users. A failure analysis component analyzes the user activity data to automatically detect likely failure events. An event filtering component intelligently accesses information from unrelated websites, interactive services, and/or offline services to determine whether an event was successfully completed by a user. One or more communications are sent to the user for select failure and successful events, preferably taking into consideration information about the event itself and information about the particular user. Such communications present the user with information about the same event or other possible events that are related to the original event that the user might be interested in completing.

### TECHNICAL FIELD

The present disclosure generally relates to methods systems for commercial transactions. More specifically, aspects of the present disclosure relate to methods and systems for determining whether an online event has been completed by a user.

### BACKGROUND

In the context of online commerce, users are given many different options when it comes to researching a product or service, making a purchase, or conducting some other type of online transaction. Often a user may begin to conduct an online transaction (e.g., by adding one or more items to a “shopping cart” in the context of online shopping), but for one reason or another not complete the transaction. For example, the user may have been interrupted or distracted by something external to the transaction (e.g., a phone call, loss of connection to the Internet, etc.), the user may not have had enough time to complete the transaction in one sitting, or the user may not have been totally prepared to complete the transaction at that time. In such situations, the user may be missing out on a great opportunity to buy a product or service that the user was initially interested in.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

One embodiment of the present disclosure relates to a method comprising: determining, by a server, that a user accessed a website associated with an electronic notification sent to the user; determining that the user accessed an event engine associated with the website; determining that the user initiated an event in the event engine, wherein the initiated event is associated with one or more goods and/or services offered by the website; storing data about the initiated event in one or more databases; determining, based on the stored data about the event, that the user abandoned the event in the event engine; determining whether the event remains abandoned by the user based on a collection of data obtained from online and/or offline sources associated with the event, wherein the collection of data includes data about one or more other websites associated the one or more goods and/or services offered by the website; and in response to determining that the event remains abandoned by the user, sending the user a notification about the abandoned event.

Another embodiment of the present disclosure relates to a system comprising one or more processors and a computer-readable medium coupled to the one or more processors having instructions stored thereon that, when executed by the one or more processors, causes the one or more processors to perform operations comprising: determining that a user accessed a website associated with an electronic notification sent to the user; determining that the user accessed an event engine associated with the website; determining that the user initiated an event in the event engine, wherein the initiated event is associated with one or more goods and/or services offered by the website; storing data about the initiated event in one or more databases; determining, based on the stored data about the event, that the user abandoned the event in the event engine; obtaining, from a collection of online and/or offline sources associated with the event, data about one or more other websites associated with the one or more goods and/or services offered by the website; determining, based on the data about the one or more other websites, whether the event remains abandoned by the user; and in response to determining that the event remains abandoned by the user, sending the user a notification about the abandoned event.

Yet another embodiment of the present disclosure relates to one or more non-transitory computer readable media storing computer-executable instructions that, when executed by one or more processors, causes the one or more processors to perform operations comprising: determining that a user accessed a website associated with an electronic notification sent to the user; determining that the user accessed an event engine associated with the website; determining that the user initiated an event in the event engine, wherein the initiated event is associated with one or more goods and/or services offered by the website; storing data about the initiated event in one or more databases; determining, based on the stored data about the event, that the user abandoned the event in the event engine; obtaining, from a collection of online and/or offline sources associated with the event, data about one or more other websites associated with the one or more goods and/or services offered by the website; determining, based on the data about the one or more other websites, whether the event remains abandoned by the user; and in response to determining that the event remains abandoned by the user, sending the user a notification about the abandoned event.

In one or more other embodiments, the methods, systems, and computer readable media described herein may optionally include one or more of the following additional features: the event engine is a web page associated with the website, the web page configured to allow the user to conduct an event associated with one or more goods and/or services offered by the website, determining that the user initiated an event in the event engine includes determining that the user conducted a search in connection with the one or more goods and/or services offered by the website using the event engine, the data stored about the initiated event includes one or more parameters of the search conducted by the user in connection with the one or more goods and/or services offered by the website, the data obtained from the one or more online and/or offline sources associated with the event includes clickstream data from one or more other websites associated with the one or more goods and/or services offered by the website, determining that the event remains abandoned by the user includes analyzing the data obtained from the one or more online and/or offline sources associated with the event, and determining, based on the analyzed data, that the event has not been completed by the user outside of the event engine; and/or the notification about the abandoned event is sent to the user after a predetermined period of time following the determination that the event remains abandoned by the user.

Further scope of applicability of the present disclosure will become apparent from the Detailed Description given below. However, it should be understood that the Detailed Description and specific examples, while indicating preferred embodiments, are given by way of illustration only, since various changes and modifications within the spirit and scope of the disclosure will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a block diagram illustrating an example system for determining whether an online event has been completed according to one or more embodiments described herein.

FIG. 2 is a flowchart illustrating an example process for determining whether an online event has been completed according to one or more embodiments described herein.

FIG. 3 is a flowchart illustrating another example process for determining whether an online event has been completed according to one or more embodiments described herein.

FIG. 4 is a block diagram illustrating an example computing device arranged for determining whether an online event has been completed according to one or more embodiments described herein.

The headings provided herein are for convenience only and do not necessarily affect the scope or meaning of the claims.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples and embodiments will now be described. The following description provides specific details for a thorough understanding and enabling description of these examples and embodiments. One skilled in the relevant art will understand, however, that the examples and embodiments described herein may be practiced without many of these details. Likewise, one skilled in the relevant art will also understand that the examples and embodiments described herein can include many other obvious features not described in detail herein. Additionally, some well-known structures or functions may not be shown or described in detail below, so as to avoid unnecessarily obscuring the relevant description.

Embodiments of the present disclosure relate to methods and systems for determining whether an event (e.g., an online event) has been successfully completed by a user. In accordance with one or more embodiments described herein, the system may include a website or other interactive service, a failure analysis component, and an event filtering component. As will be described in greater detail below, the website or interactive service may maintain user activity data reflective of the activities of its users, and the failure analysis component may analyze the user activity data to automatically detect likely failure events. The event filtering component may be configured to intelligently access information from unrelated websites, interactive services, and/or offline services to determine whether an event was successfully completed by a user.

In accordance with at least one embodiment, one or more communications may be sent to a user for select failure and successful events, preferably taking into consideration information about the event itself and information about the particular user. Such communications may present the user with, for example, information about the same event or other possible events that are related to the original event that the user might be interested in completing.

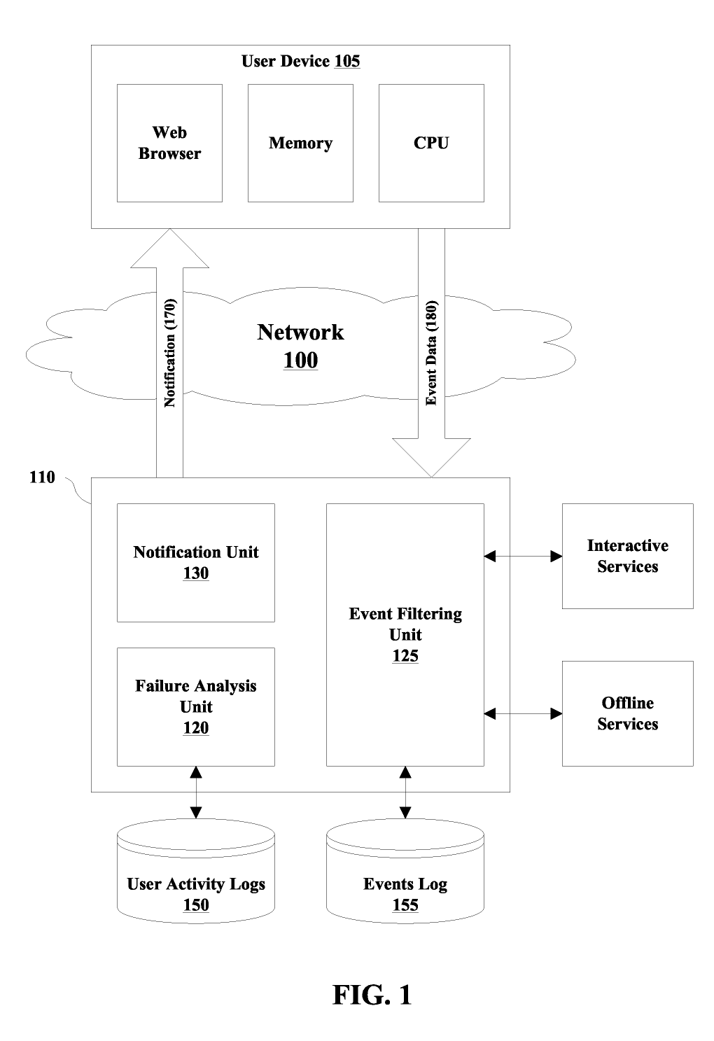

FIG. 1 illustrates an example system for determining whether an event has been completed by a user according to at least one embodiment of the present disclosure. The system 110 may include a failure analysis unit 120, a notification unit 130, and an event filtering unit 125. The system 110 may also maintain and/or have access to user activity logs 150 and an events log 155.

A website or other interactive service may maintain user activity data reflective of the activities of its users in connection with the website. Such user activity data may be maintained in user activity logs 150. The failure analysis unit 120 may analyze the user activity data stored in the user activity logs 150 to determine whether an event has been completed. As used herein, an “event” may refer to any of a variety of online activities that may be performed by a user. One example of an event is a purchase transaction made by the user, whereby the user makes an online purchase of a product or service. An event that is initiated by a user, but not completed (or in some embodiments neither completed nor affirmatively canceled) by the user may be considered a “failure event.”

For example, in the context of online shopping, a shopping cart contains the specific details of what an online shopper is looking to buy and enables them to conduct an online transaction and make a purchase. If an online shopper fails to make the purchase (e.g., by not completing the “check-out” process), the shopping cart may be considered to be “abandoned.” An abandoned shopping cart is an example of a “failure event.”

It should be noted, however, that other user actions or inactions, and/or occurrences may also constitute “failure events” in addition to or instead of an abandoned shopping cart, which is merely used as an example. While the following description provides many examples in the contexts of online shopping and online reservations, these contexts are not intended to limit the scope of the present disclosure. Instead, one or more embodiments described herein may be useful and applicable to other contexts as well.

An event filtering unit 125 may be configured to intelligently access information from unrelated websites, interactive services, and/or offline services to determine whether an event was successfully completed by a user.

The notification unit 130 may be configured to send a notification 170 to the user (e.g., to the user's device 105) for select failure and successful events. Depending on the implementation (and also any expressed preferences of the user), the notification 170 may be sent to the user via e-mail, SMS text message, Twitter, Facebook, instant chat message, or any combination thereof, as well as through various other Internet communication channels forthcoming or currently available.

In accordance with at least one embodiment, the notification unit 130 may consider information about the event itself, and information about the particular user, when generating the notification 170. For example, the notification 170 may present information about the particular event and/or other related events that the user might be interested in completing.

The system 110 may also include various other components in addition to or instead of the components shown in FIG. 1. It should also be noted that, depending on the particular implementation, one or more of the components shown as being part of the system in FIG. 1 may also operate independently of the system 110 and/or independently of other components in the system 110.

Continuing with the abandoned shopping cart example, when an abandoned shopping cart is discovered through a failure detection process (e.g., by failure analysis unit 120 as shown in the example system of FIG. 1), analysis of data gathered through other online sources and offline sources may be used to determine whether or not the online shopper completed the purchase through another source (e.g., via another website or service). In at least one embodiment, the failure detection process may be performed at regular time intervals (e.g., every 2 hours, 6 hours, 24 hours, etc.), which may be adjusted as necessary or desired. At each time interval, the failure detection process may utilize user activity data in connection with the website to identify shoppers who have started an event (e.g., the “booking process” in the context of the hospitality industry) in an event engine of the website, but not completed the event in the event engine.

After identifying users who have not completed the event in the event engine, the failure detection process may gather data through other online and/or offline sources. For example, in the context of the hospitality industry, the failure detection process may collect clickstream data from the website of a hotel associated with the event. Data may also be obtained from an applicable property management system (PMS) and/or central reservation system (CRS). The data gathered from these other sources may then be analyzed to determine whether or not the user completed the purchase through another source.

If the user's shopping cart is deemed to still be abandoned, using data stored in a database about the online shopper, one or more messages (e.g., notification 170) may be sent to the online shopper encouraging the completion of the same purchase, a similar purchase or a different purchase that might be of interest. If the shopping cart was deemed to have been successfully completed by the failure detection process, or completed by an online shopper using the original shopping cart, one or more follow-up messages can be sent to the user offering services relating to the purchase.

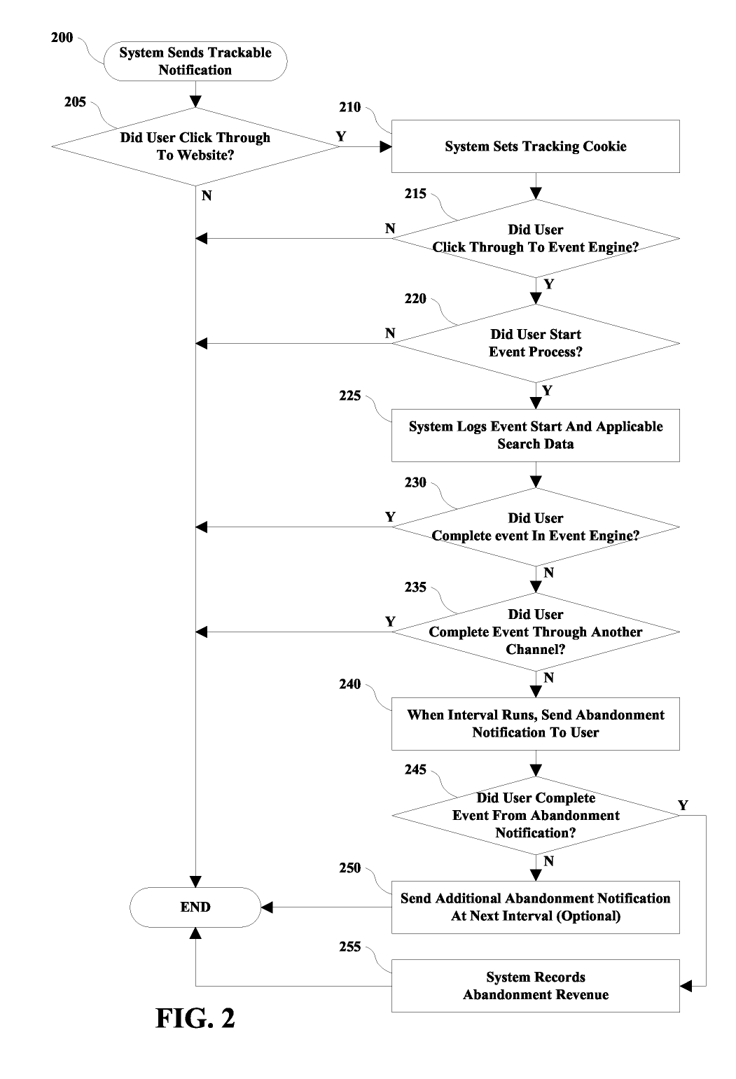

FIG. 2 illustrates an example process for determining whether an event has been completed according to one or more embodiments of the present disclosure.

The process may begin at block 200, where the system may send a trackable notification to a user (e.g., notification 170 as shown in FIG. 1). For example, a marketing e-mail may be sent to the user advertising a particular product or service.

At block 205, a determination may be made as to whether the user clicked-through (or otherwise interacted with) the notification to access a corresponding website. If it is determined at block 205 that the user did click-through the notification to the website, the process may move to block 210. On the other hand, if it is determined at block 205 that the user did not access the website via the notification sent at block 200, the process may terminate.

At block 210, the system may set a tracking cookie for the user (e.g., stored in the user's browser).

At block 215, a determination may be made as to whether the user clicked-through to (or otherwise accessed) an event engine associated with the website. For example, depending on the particular contents of the notification sent to the user at block 200, the user may click-through to a specific web page or component of the website that provides the user with the ability to conduct an event (e.g., a booking engine, reservation service, etc.). For example, where the website is associated with a hotel, the user may access a web page or service that enables the user to make a room reservation. If it is determined at block 215 that the user did not click-through to the event engine, the process may terminate. However, if it is determined at block 215 that the user did click-through to or otherwise access the event engine, the process may move to block 220.

At block 220, a determination may be made as to whether the user started the event process. The determination may be based on various actions performed by the user in connection with the event engine. For example, the user may be deemed to have started the event process if the user conducts a search in connection with a product or service offered by the website. An example scenario is where the user searches for hotel room availability on a particular date. If it is determined that the user did not start the event process, the process may terminate. However, if the user did initiate the event process at block 220, the process may continue to block 225 where the system may log an “event start” for the user along with other relevant data (e.g., search parameters entered by the user, products and/or services viewed by the user, etc.).

At block 230 of the process, a determination may be made as to whether the user completed the event in the event engine. If the user did complete the event in the event engine, the process may terminate. If the user did not complete the event, the process may move to block 235, where it is determined whether the user completed the event through another channel or source (e.g., a non-affiliated website or service).

As described above, after determining that the user has not completed the event in the event engine (e.g., at block 230), a failure detection process may gather relevant data through other online and/or offline sources (e.g., clickstream data from websites, PMS/CRS, etc.). The data gathered from these other sources may then be analyzed to determine whether or not the user completed the event through another channel. If the user is found to have completed the event through another channel, the process may terminate. If it is determined that the user has not completed the event through another channel, the process may move to block 240.

At block 240, the process may determine a specified time interval has passed and thus send an abandonment notification (e.g., notification 170 as shown in FIG. 1) to the user. The abandonment notification may be sent to the user via e-mail, SMS text message, Twitter, Facebook, instant chat message, or any combination thereof, as well as through various other Internet communication channels forthcoming or currently available.

At block 245, a determination may be made as to whether the user completed the event from the abandonment notification sent at block 240. For example, the user's actions with respect to the abandonment notification may be tracked such that the system may detect if the user clicks-through the abandonment notification to access the website, recommences (e.g., reactivates, renews, restores, reopens, etc.) the event in the event engine, and completes the event. If it is determined that the user did complete the event from the abandonment notification, the process may move to block 255, where abandonment revenue may be recorded and the process then terminates. If it is determined that the user did not complete the event from the abandonment notification, the process may move to block 250, where an additional abandonment notification may be sent to the user at the next time interval.

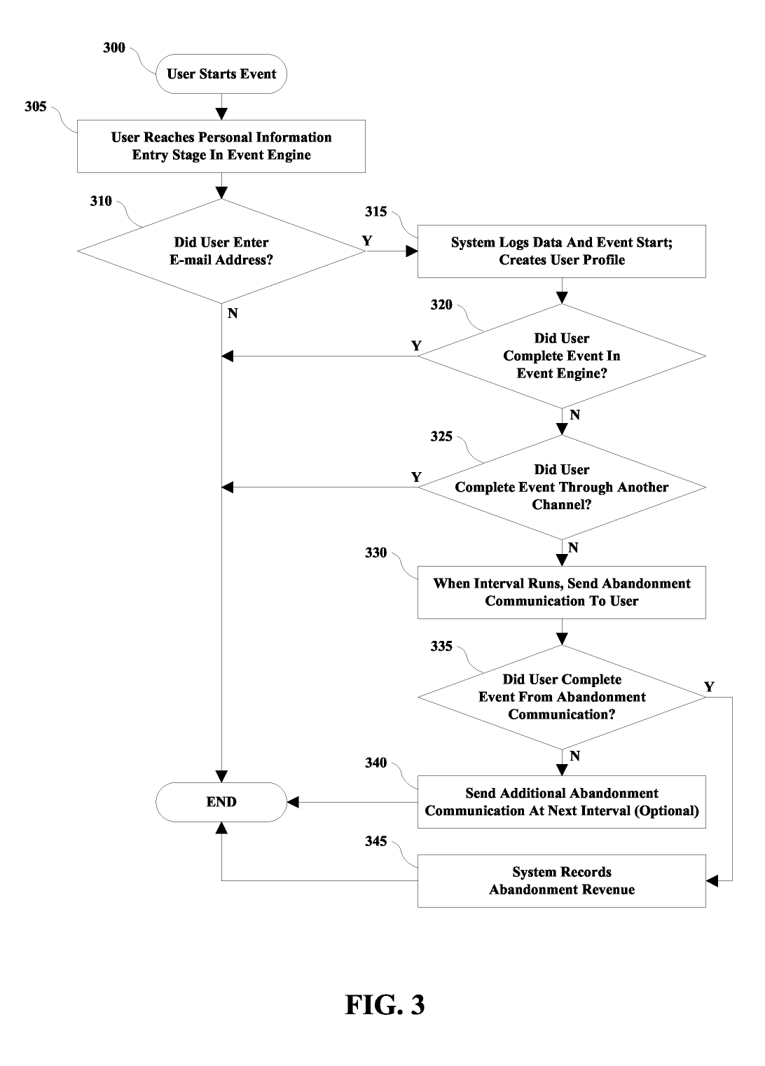

FIG. 3 illustrates another example process for determining whether an event has been completed according to one or more embodiments of the present disclosure.

The process may begin at block 300, where the user starts an event, such as an online purchase, online reservation, and the like. In at least one embodiment, the user may start the event in an event engine associated with a particular website (e.g., a reservation booking engine of a hotel's website).

At block 305, it is determined that the user has reached the personal information entry stage in the event engine. For example, the user may be asked to enter his or her identification and/or contact information, such as phone number, mailing address, e-mail address, etc.

The process may then move to block 310, where a determination is made as to whether the user entered an e-mail address at the personal information entry stage. If no e-mail address was entered by the user, then the process may terminate. On the other hand, if the user did enter an e-mail address, the process may move to block 315 where the system may log an “event start” for the user, along with other relevant data about the user and the event, and create a profile for the user.

The process illustrated in FIG. 3 may proceed through the remaining blocks 320 through 345 in a similar manner as the process illustrated in FIG. 2 proceeds through blocks 230 through 255, as described above. Therefore, for purposes of brevity, remaining blocks 320 through 345 will not be described.

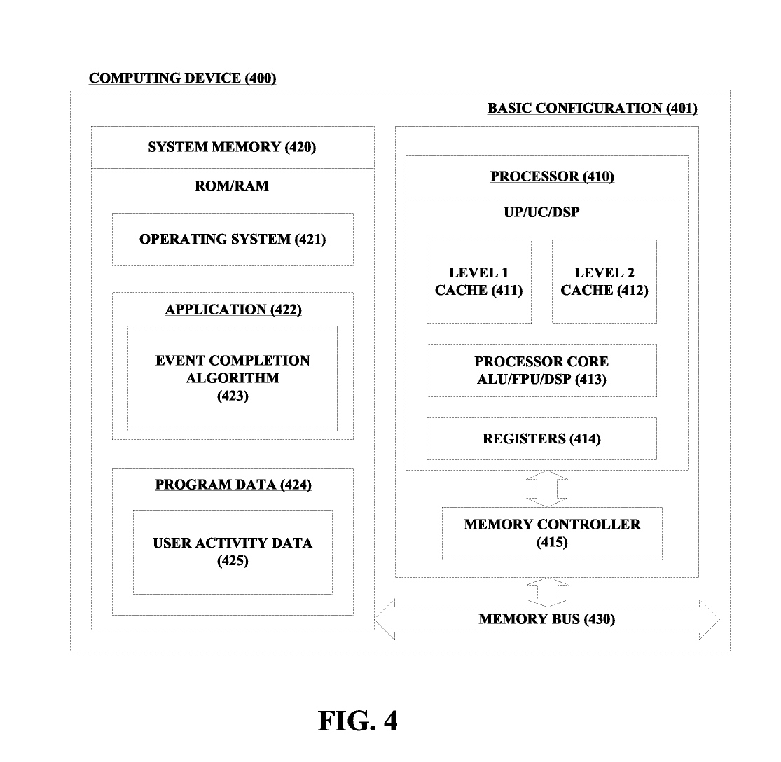

FIG. 4 is a high-level block diagram of an exemplary computer (400) that is arranged for determining whether an online event has been completed by a user, in accordance with one or more embodiments of the present disclosure. In a very basic configuration (401), the computing device (400) typically includes one or more processors (410) and system memory (420). A memory bus (430) can be used for communicating between the processor (410) and the system memory (420).

Depending on the desired configuration, the processor (410) can be of any type including but not limited to a microprocessor (μP), a microcontroller (μC), a digital signal processor (DSP), or any combination thereof. The processor (410) can include one more levels of caching, such as a level one cache (411) and a level two cache (412), a processor core (413), and registers (414). The processor core (413) can include an arithmetic logic unit (ALU), a floating point unit (FPU), a digital signal processing core (DSP Core), or any combination thereof. A memory controller (415) can also be used with the processor (410), or in some implementations the memory controller (415) can be an internal part of the processor (410).

Depending on the desired configuration, the system memory (420) can be of any type including but not limited to volatile memory (such as RAM), non-volatile memory (such as ROM, flash memory, etc.) or any combination thereof. System memory (420) typically includes an operating system (421), one or more applications (422), and program data (424). The application (422) may include an event completion algorithm (423) configured to determine whether an online event (e.g., a purchase transaction, reservation request, etc.) has been successfully completed by a user. Program Data (424) may include storing instructions that, when executed by the one or more processing devices, implement the event completion algorithm (423). Additionally, in accordance with at least one embodiment, program data (424) may include user activity data (425), which may relate to activities of users in connection with a website and/or interactive service. In some embodiments, the application (422) can be arranged to operate with program data (424) on an operating system (421) such that the event completion algorithm (423) performs failure analysis using the user activity data (425) to automatically detect likely failure events. Further, in accordance with one or more other embodiments, the application (422) can be arranged to operate with program data (424) on an operating system (421) such that the event completion algorithm (423) intelligently accesses information from unrelated websites, interactive services, and/or offline services to determine whether an event was successfully completed by a user.

The computing device (400) can have additional features or functionality, and additional interfaces to facilitate communications between the basic configuration (401) and any required devices and interfaces.

System memory (420) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media can be part of the device (400).

The computing device (400) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that include any of the above functions. The computing device (400) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In situations in which the systems discussed here collect personal information about users, or may make use of personal information, the users may be provided with an opportunity to control whether programs or features collect user information (e.g., information about a user's location, a user's preferences, a user's online activities, etc.).

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
determining, by a server, that a user accessed a website associated with an electronic notification sent to the user;
determining that the user accessed an event engine associated with the website;
determining that the user initiated an event in the event engine, wherein the initiated event is associated with one or more goods and/or services offered by the website;
storing data about the initiated event in one or more databases;
determining, based on the stored data about the event, that the user abandoned the event in the event engine;
determining whether the event remains abandoned by the user based on a collection of data obtained from online and/or offline sources associated with the event, wherein the collection of data includes data about one or more other websites associated with the one or more goods and/or services offered by the website; and
in response to determining that the event remains abandoned by the user, sending the user a notification about the abandoned event.

2. The method of claim 1, further comprising:
determining that the user re-accessed the website via the notification about the abandoned event; and
determining that the user completed the event in the event engine.

3. The method of claim 2, further comprising:
in response to determining that the event remains abandoned by the user after a predetermined period of time has elapsed since the user re-accessed the website, sending the user an additional notification about the abandoned event.

4. The method of claim 1, further comprising sending, by the server, an electronic notification to a user device associated with the user, wherein the electronic notification includes information about the associated website.

5. The method of claim 1, wherein the event engine is a web page associated with the website, the web page configured to allow the user to conduct an event associated with one or more goods and/or services offered by the website.

6. The method of claim 1, further comprising:
in response to determining, based on the collection of data obtained from the online and/or offline sources associated with the event, that the user completed the event outside of the event engine, sending the user a notification about one or more other goods and/or services related to the completed event.

7. The method of claim 1, wherein determining that the user initiated an event in the event engine includes:
determining that the user conducted a search in connection with the one or more goods and/or services offered by the website using the event engine, wherein the data stored about the initiated event includes one or more parameters of the search conducted by the user in connection with the one or more goods and/or services offered by the website.

8. The method of claim 1, wherein the collection of data obtained from the online and/or offline sources associated with the event includes clickstream data from the one or more other websites associated with the one or more goods and/or services offered by the website.

9. The method of claim 1, wherein determining that the event remains abandoned by the user includes:
analyzing the collection of data obtained from the online and/or offline sources associated with the event; and
determining, based on the analyzed data, that the event has not been completed by the user outside of the event engine.

10. The method of claim 1, wherein the notification about the abandoned event is sent to the user after a predetermined period of time following the determination that the event remains abandoned by the user.

11. The method of claim 1, further comprising:
in response to determining that the user initiated an event in the event engine, determining that the user entered information about the user in the event engine;
generating a user profile for the user based on the entered information about the user; and
storing the user profile with the data about the initiated event in the one or more databases.

12. A system comprising:
one or more processors; and
a computer-readable medium coupled to said one or more processors having instructions stored thereon that, when executed by said one or more processors, causes said one or more processors to perform operations comprising:
determining that a user accessed a website associated with an electronic notification sent to the user;
determining that the user accessed an event engine associated with the website;
determining that the user initiated an event in the event engine, wherein the initiated event is associated with one or more goods and/or services offered by the website;
storing data about the initiated event in one or more databases;
determining, based on the stored data about the event, that the user abandoned the event in the event engine;
obtaining, from a collection of online and/or offline sources associated with the event, data about one or more other websites associated with the one or more goods and/or services offered by the website;
determining, based on the data about the one or more other websites, whether the event remains abandoned by the user; and
in response to determining that the event remains abandoned by the user, sending the user a notification about the abandoned event.

13. The system of claim 12, wherein the one or more processors are caused to perform further operations comprising:
determining that the user re-accessed the website via the notification about the abandoned event; and
determining that the user completed the event in the event engine.

14. The system of claim 13, wherein the one or more processors are caused to perform further operations comprising, in response to determining that the event remains abandoned by the user after a predetermined period of time has elapsed since the user re-accessed the website, sending the user an additional notification about the abandoned event.

15. The system of claim 12, wherein the one or more processors are caused to perform further operations comprising sending an electronic notification to a user device associated with the user, wherein the electronic notification includes information about the associated website.

16. The system of claim 12, wherein the event engine is a web page associated with the website, the web page configured to allow the user to conduct an event associated with one or more goods and/or services offered by the website.

17. The system of claim 12, wherein the one or more processors are caused to perform further operations comprising:
in response to determining, based on the data about the one or more other websites, that the user completed the event outside of the event engine, sending the user a notification about one or more other goods and/or services related to the completed event.

18. The system of claim 12, wherein the one or more processors are caused to perform further operations comprising:
determining that the user conducted a search in connection with the one or more goods and/or services offered by the website using the event engine,
wherein the data stored about the initiated event includes one or more parameters of the search conducted by the user in connection with the one or more goods and/or services offered by the website.

19. The system of claim 12, wherein the data obtained from the online and/or offline sources associated with the event includes clickstream data from the one or more other websites associated with the one or more goods and/or services offered by the website.

20. The system of claim 12, wherein the one or more processors are caused to perform further operations comprising:
analyzing the data obtained from the online and/or offline sources associated with the event; and
determining, based on the analyzed data, that the event has not been completed by the user outside of the event engine.

21. The system of claim 12, wherein the notification about the abandoned event is sent to the user after a predetermined period of time following the determination that the event remains abandoned by the user.

22. The system of claim 12, wherein the one or more processors are caused to perform further operations comprising:
in response to determining that the user initiated an event in the event engine, determining that the user entered information about the user in the event engine;
generating a user profile for the user based on the entered information about the user; and
storing the user profile with the data about the initiated event in the one or more databases.

23. One or more non-transitory computer readable media storing computer-executable instructions that, when executed by one or more processors, causes the one or more processors to perform operations comprising:
determining that a user accessed a website associated with an electronic notification sent to the user;
determining that the user accessed an event engine associated with the website;
determining that the user initiated an event in the event engine, wherein the initiated event is associated with one or more goods and/or services offered by the website;
storing data about the initiated event in one or more databases;
determining, based on the stored data about the event, that the user abandoned the event in the event engine;
obtaining, from a collection of online and/or offline sources associated with the event, data about one or more other websites associated with the one or more goods and/or services offered by the website;
determining, based on the data about the one or more other websites, whether the event remains abandoned by the user; and
in response to determining that the event remains abandoned by the user, sending the user a notification about the abandoned event.
